(19) United States
(12) Patent Application Publication
(10) Pub. No.: US 2005/0033682 A1
(43) Pub. Date: Feb. 10, 2005

(54) Method for facilitating purchasing of advertising via electronic auction

(76) Inventors: Douglas A. Levy, Dallas, TX (US); Angela Byrnes, Euless, TX (US); Stephen Paul Minichini, Norwalk, CT (US); Marc Blumberg, Dallas, TX (US)

Correspondence Address: Daniel H. Golub, 1701 Market Street, Philadelphia, PA, 19103, US

(21) Appl. No.: 10/894,252

(22) Filed: Jul. 19, 2004

Related U.S. Application Data
(60) Provisional application No. 60/492,387, filed on Aug. 4, 2003.

(51) Int. Cl. G06F 17/60

(52) U.S. Cl. 705/37; 705/27

(57) ABSTRACT

A method for facilitating purchasing of advertising via an electronic auction. A purchase price indicating the amount that an advertising purchaser is willing pay for advertising is set. A bid from potential advertising sellers is received over a computer network. The bid includes a quantity each potential advertising seller is willing to provide in exchange for the purchase price. A winning bid is identified based on the quantity of advertising each potential advertising seller is willing to provide.

### CROSS REFERENCE TO RELATED APPLICATIONS

This application claims priority to U.S. Provisional Patent Application No. 60/492,387, filed Aug. 4, 2003, and entitled “Method for Securing Online Media Campaigns” which is hereby incorporated by reference in its entirety.

### BACKGROUND OF THE INVENTION

1. Field of the Invention

The present invention relates to methods for purchasing advertising and, in particular, methods for ensuring competitive bidding for purchase of advertising by bringing together media vendors in a way that enhances the value of media buys for advertisers.

2. Background

The media marketplace is vast, diverse and complex. With hundreds of vendors offering millions of advertising impressions every day, the sheer volume of unique marketing opportunities if staggering. Couple this with the ever-increasing complexity of media buying and the need for an innovative buying solution has never been more critical. Prior to the present invention, media buyers would issue requests for proposal and review the responses of the media vendors. Upon selecting a vendor, contract negotiations would commence and, depending on the size of the buy, would take several weeks to conclude. Thus, prior art processes for media buying were cumbersome and inefficient. While prior art processes include an electronic means for managing the paperwork associated with the media purchasing process, none of these processes ensure that the advertiser is getting the best deal possible.

### SUMMARY OF THE INVENTION

The present invention is directed to a method for facilitating purchasing of advertising via an electronic auction. A purchase price, comprising an amount that an advertising purchaser is willing pay for advertising, is set. A bid from one or more potential advertising sellers is received over a computer network. The bid comprises a quantity of advertising each potential advertising seller is willing to provide in exchange for the purchase price. A winning bid is identified based on at least one of the quantity of advertising each potential advertising seller is willing to provide.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 illustrates an exemplary invitation sent to a media vendor;

FIG. 2 illustrates details for an exemplary program that will be the subject of an auction;

FIG. 3 illustrates exemplary criteria that may be reviewed in connection with a media vendor's potential participation in an auction;

FIG. 4 illustrates details for an exemplary program that will be the subject of an auction;

FIG. 5 is a flow chart illustrating the auction day process;

FIG. 6 illustrates an exemplary virtual bidding room;

FIG. 7 illustrates details for an exemplary program that will be the subject of an auction;

FIG. 8 illustrates exemplary results of the auction carried out for the program details illustrated in FIG. 7; and

FIG. 9 is a flow chart illustrating a method for facilitating purchasing of advertising via an electronic auction.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

The present invention relates to purchasing advertising (including on-line advertising such as impressions, clicks, and acquisitions) via an on-line auction. In particular, the invention provides an opportunity for media vendors to sell their properties through a bid-driven, on-line, media buying process. Vendors bid against each other simultaneously, thereby resulting in competition that dramatically increases the amount of media inventory, reduces the time of negotiation between media buyers and media vendors, and creates a more effective overall media buy.

As an initial step, a media buyer defines the media program that will be the subject of the auction, including objectives for the campaign, campaign start and end dates, minimum criteria for campaign success, and a budgetary commitment for the media buy.

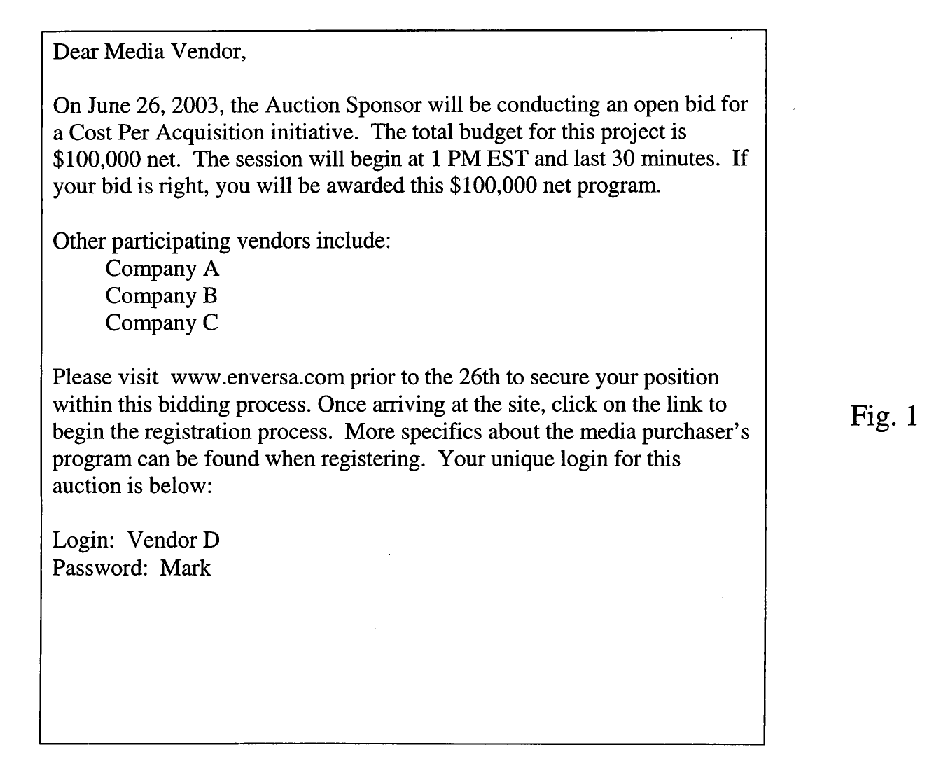

A group of media vendors that fulfill the minimum requirements for the program are pre-selected. In one embodiment, the pre-selected vendors also meet certain quality standards. To assist with quality assessment, score cards for vendors may be maintained, reflecting each vendor's past performance for specific buys. The pre-selected media vendors are sent an electronic invitation to the auction. In one embodiment, this occurs one week before the auction is to commence to allow the media vendor time to study the program under consideration, ask questions, and develop a bidding strategy. With reference to FIG. 1, an exemplary electronic invitation is shown.

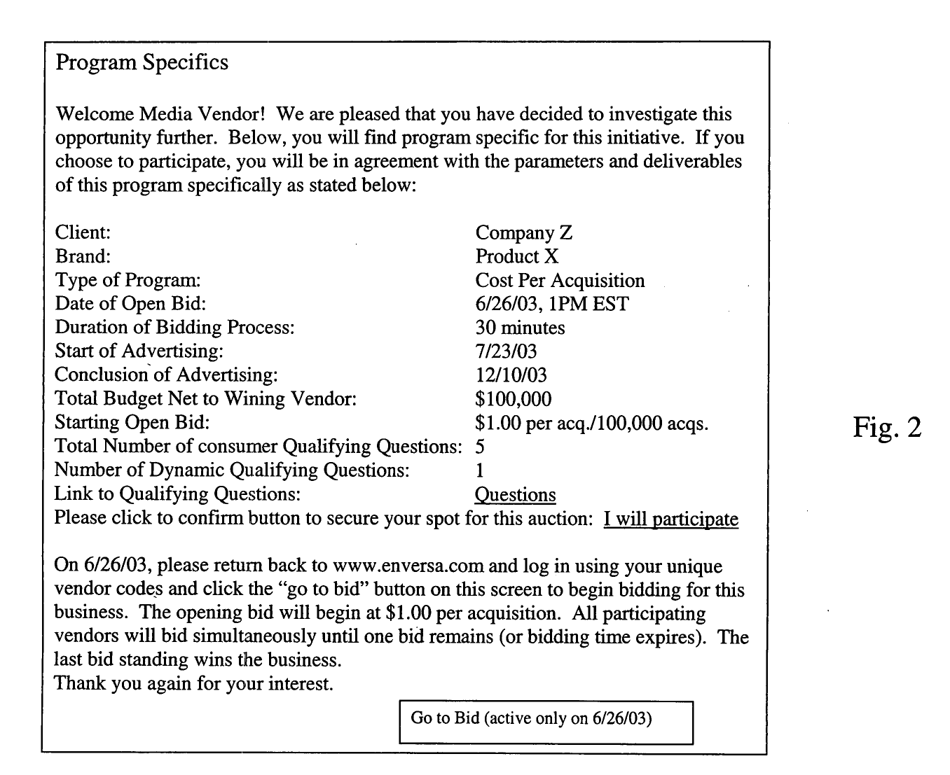

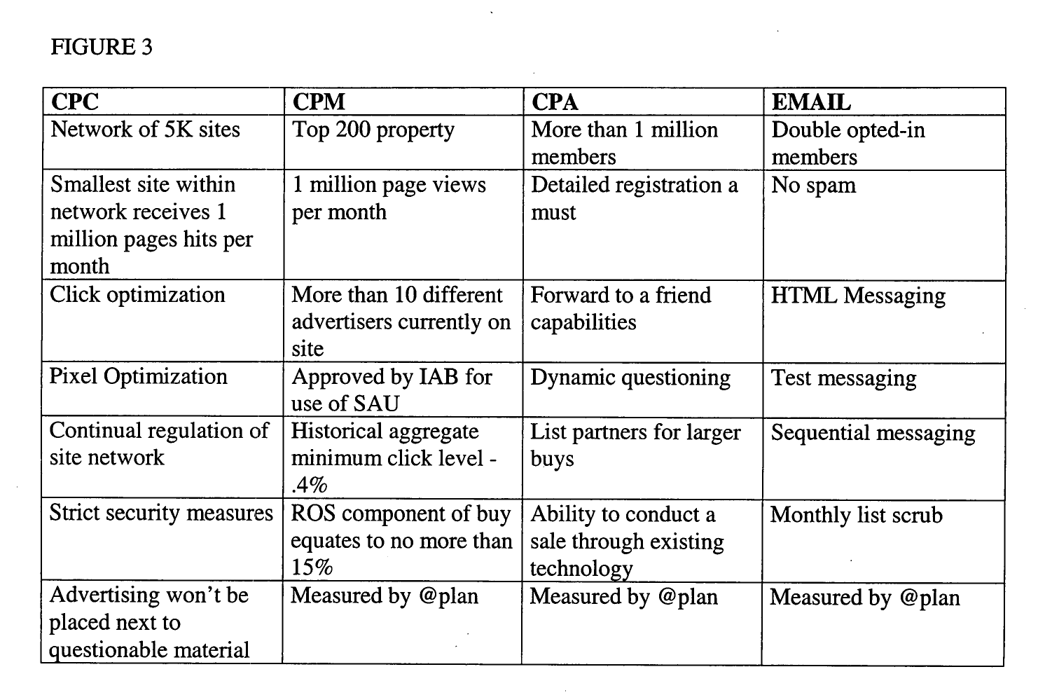

Upon receipt of the electronic invitation, the media vendor follows the URL in the invitation and, upon reaching the site associated with the URL, logs in using the unique user identifier and password provided in the invitation. Here, the media vendor can view the specific program under consideration, as shown in FIG. 2. In particular, the vendor can see information such as net revenue for the program, type of program, advertising window, and minimum inventory (i.e., acquisitions, clicks, impressions). After reviewing the program details, the vendor confirms its intent to participate in the auction. In some embodiments, rather than the vendor quality assessment being performed up front, the quality of the vendor is assessed at the time the vendor opts to participate in the auction. This assessment is performed by asking the vendor one or more qualifying questions. Exemplary subject areas covered by the questions are illustrated with reference to FIG. 3.

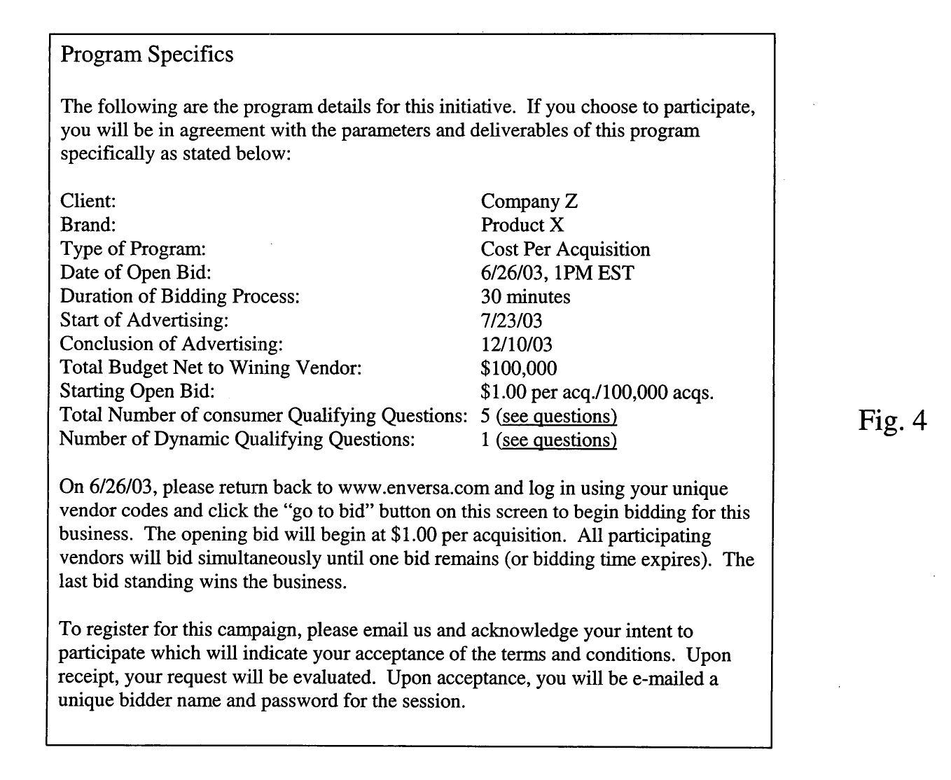

In still other embodiments, upcoming auctions are listed on a web site, in addition to or in lieu of sending invitations to select vendors. When the vendor clicks on an auction of interest listed on the web site, the program details are provided, as illustrated in FIG. 4. In this embodiment, the vendor will be required to register and answer certain questions used to assess the quality of the vendor and its services. For example, the vendor may be asked questions regarding one or more of the criteria identified in FIG. 3. In this embodiment, the vendor is qualified based on the information submitted and, thereafter, is provided with an electronic message containing the vendor's unique identification number and password to be used for participating in the auction.

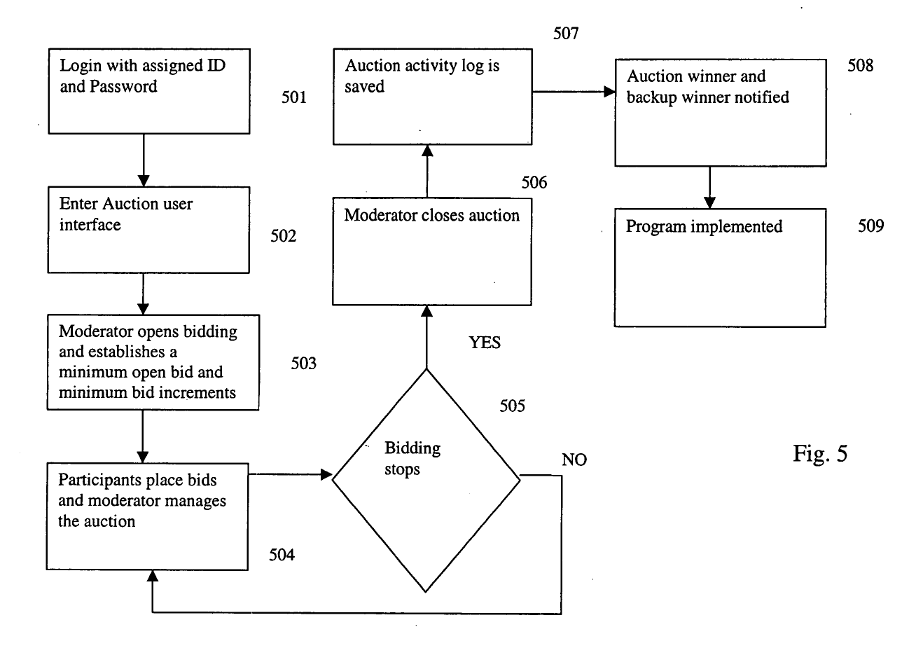

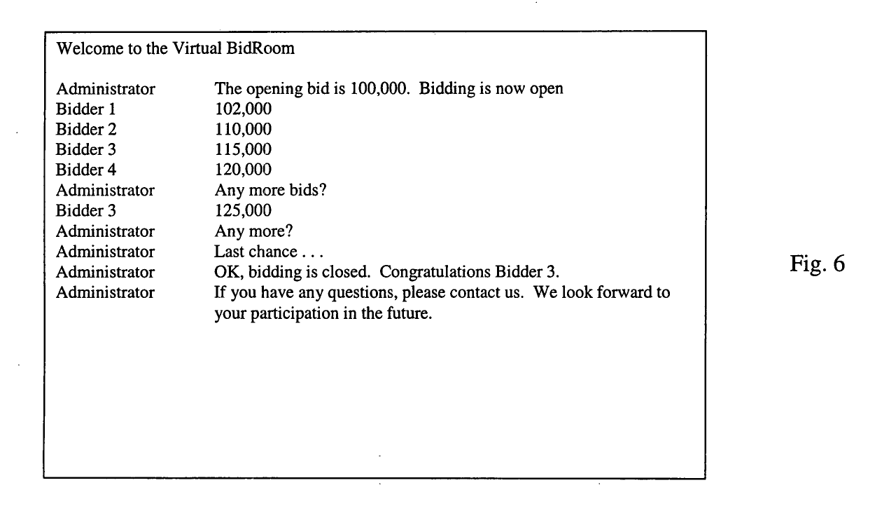

With reference to FIG. 5, the auction process is illustrated. Each vendor participating in the auction navigates to the site designated for the auction at the pre-determined date and time and logs in with its assigned identifier and password, in step 501. In step 502, the vendor enters the virtual bidding room. An exemplary virtual bidding room is illustrated with reference to FIG. 6. Many types of “off-the-shelf” software that enables interaction among users on the web can be used to implement the virtual bidding room in accordance with the present invention and will be known to those skilled in the art. For example, ParaChat Professional, described in detail at www.parachat.com/professional/, which is incorporated herein by reference, can be used. Other types of chat software can be used in connection with the invention depending on the requirements of the particular situation (e.g., security).

In a preferred embodiment, each vendor is informed of all the vendors taking part in the auction prior to the auction taking place. However, the vendors will not be identifiable to each other during the actual bidding process, as code names are used.

Prior to the commencement of bidding, the moderator may review the rules of the auction. Thereafter, in step 503, the moderator opens bidding and may establish a minimum opening bid and minimum bidding increments. In accordance with the present invention, the dollar amount for the bid is fixed. The vendor's bids are inventory-based and increase over the course of the auction. For example, the bids increase as to how many acquisitions the vendor will provide for a $50,000 cost-per-acquisition (CPA) campaign. When the bid begins, each vendor enters its bid for the particular inventory requested, in step 504. When a bid is posted, each vendor will see the amount; however, only the moderator/auction sponsor and the media buyer will know which vendor submitted which bid.

The moderator is preferably involved in the bidding to ensure an active process. When a time period (e.g., one minute) passes with no new bids, the moderator will notify vendors of the remaining time to ensure all final bids are submitted. When the bidding stops, in step 505, the moderator closes the auction, in step 506. The auction activity log is saved, in step 507. The last vendor to submit the highest inventory bid will win the business. The moderator announces the winner and a backup winner in step 508. Thereafter, a contract between the media buyer and the winning media vendor is signed and the program implemented in step 509.

In one embodiment, the various classes of media that can be included in the program may be specified, along with the minimum percentage allocations for each (e.g., some classes of media could be based on placement, ad unit size, or technology). In this embodiment, the winner of the bid is required to accept the total amount of inventory that results from the bidding process and split that total inventory between various media classes specified in the program details.

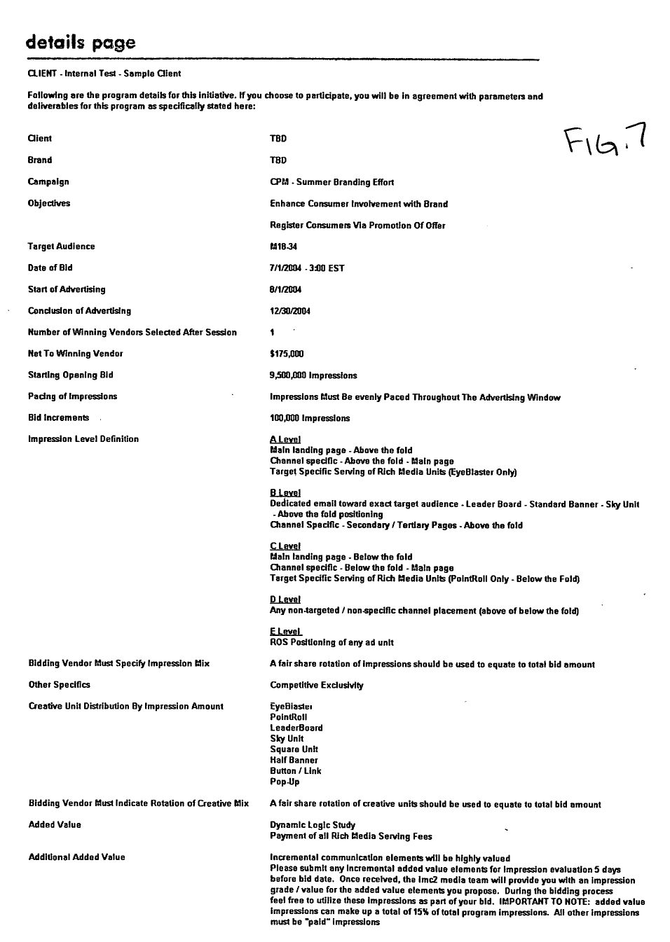

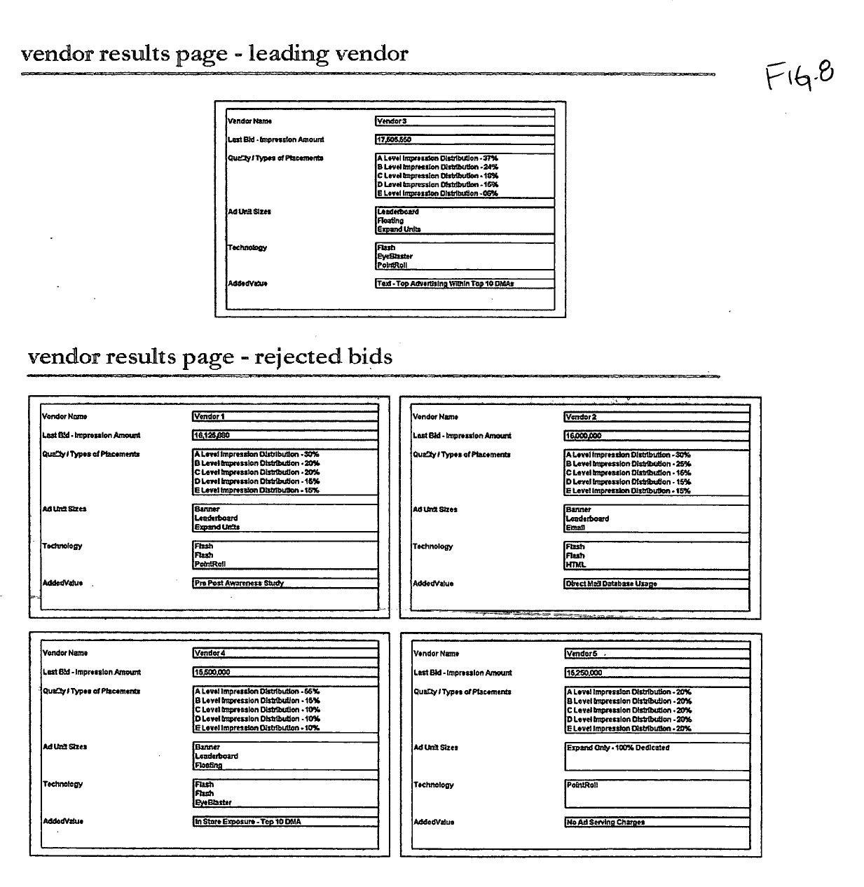

In another embodiment of the auction process, the bidders are required to submit a complete program, which would include various quantities of inventory, types of placement, ad unit size, and media technology. An example of the program details for this type of auction process is shown with reference to FIG. 7. All of the submissions are reviewed and the best one is chosen. The choice of the best submission may be subjective (i.e., the advertising purchase and/or the auction proprietor may review the bids and choose which one has the best mix of benefits). In an alternative embodiment, a formula may be used. By way of example, each proposal may be ranked from 1-100 based on the four criteria referenced above, with a particular weighting factor applied to each of the criteria. The reputation of the bidder may also be considered in determining the best bid. The chosen program is posted and the bidders in the auction are then invited to submit a subsequent round of proposed programs, in competition with the chosen program. This process may be repeated for several rounds, with winners of each round being recognized and posted, until the program that is most compelling to the advertising purchaser is presented. For example, once the programs submitted by the bidders do not improve with reference to a previous round, the last recognized bidder would be deemed the winner. FIG. 8 illustrates, in an exemplary fashion, the results of the auction carried out for the exemplary program details illustrated in FIG. 7.

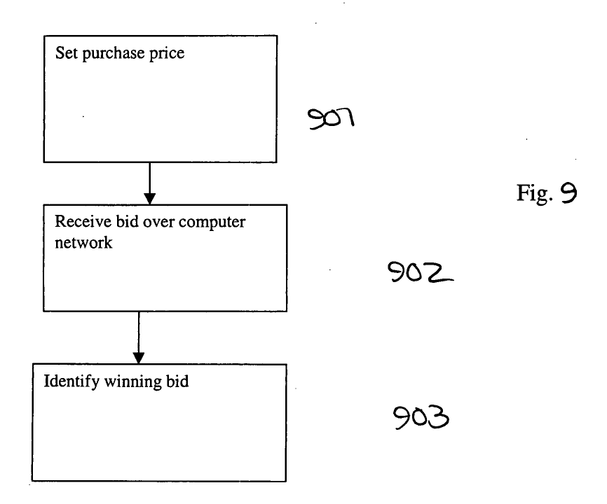

With reference to FIG. 9, a method for facilitating purchasing of advertising via an electronic auction is illustrated. In step 901, a purchase price comprising an amount that an advertising purchaser is willing to pay for advertising is set. In step 902, a bid from one or more potential advertising sellers is received over a computer network. The bid comprises a quantity of advertising each potential advertising seller is willing to provide in exchange for the purchase price. In step 903, a winning bid is identified based on the quantity of advertising each potential advertising seller is willing to provide.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

1. A method for facilitating purchasing of advertising via an electronic auction comprising:
(A) setting a purchase price comprising an amount that an advertising purchaser is willing pay for advertising;
(B) receiving, over a computer network, a bid from one or more potential advertising sellers, wherein the bid comprises a quantity of advertising each potential advertising seller is willing to provide in exchange for the purchase price; and
(C) identifying a winning bid based on the quantity of advertising each potential advertising seller is willing to provide.
